(19) United States
(12) Patent Application Publication
(10) Pub. No.: US 2013/0046558 A1
(43) Pub. Date: Feb. 21, 2013

(54) System and Method for Identifying Inconsistent and/or Duplicate Data in Health Records

(71) Applicants: William A. Landi, Devon, PA (US); Faisal Farooq, Norristown, PA (US); Farbod Rahmanian, Leesport, PA (US); Bharat Rao, Berwyn, PA (US)

(72) Inventors: William A. Landi, Devon, PA (US); Faisal Farooq, Norristown, PA (US); Farbod Rahmanian, Leesport, PA (US); Bharat Rao, Berwyn, PA (US)

(73) Assignee: Siemens Medical Solutions USA, Inc., Malvern, PA (US)

(21) Appl. No.: 13/589,400

(22) Filed: Aug. 20, 2012

Related U.S. Application Data
(60) Provisional application No. 61/524,788, filed on Aug. 18, 2011.

(51) Int. Cl. G06Q 50/24

(52) U.S. Cl. 705/3

(57) ABSTRACT

A method of identifying information in electronic medical records includes receiving one or more electronic medical records extracted from at least one source. Each of the one or more electronic medical records has medical information of at least one medical patient. The method also includes analyzing, via a processor, the medical information by comparing different portions of data in the medical information. The method further includes identifying, via the processor, at least one of: (i) the different portions of data in the medical information as inconsistent data; and (ii) the different portions of the data in the medical information as duplicate data.

### CROSS REFERENCE TO RELATED APPLICATIONS

This application claims priority to U.S. Provisional Patent Application No. 61/524,788, filed on Aug. 18, 2011.

### TECHNOLOGY FIELD

Embodiments of the present invention relate to methods and systems for improving patient health care. In particular, it relates to systems and methods for analyzing and identifying inconsistent data and/or duplicate data in “electronic” patient health records.

### BACKGROUND

Conventional information technology systems (e.g., Electronic Health Record (EHR) and Computerized Prescriber Order Entry (CPOE)) continue to play a significant role in cost reduction, quality measurement and improvement for health care. These conventional information technology systems benefit from having medical information in a structured format. Data in a structured format (structured data) includes data that is organized by specific headings and labels that are easily interpretable by a computer system. For example, structured data may include patient information inputted into pre-defined fields as well as clinical, financial, laboratory databases. An example of an electronic medical record having information in a structured format is shown and described, for example, in U.S. Pat. No. 7,181,375, which is incorporated by reference in its entirety.

Data in an unstructured format (unstructured data) may not be easily interpretable by a computer system. For example, unstructured data may include free text notes such as a doctor's notes, wave forms, images, MR (magnetic resonance) images and CT (computerized tomography) scans, dictation, ASCII text strings, image information in DICOM (Digital Imaging and Communication in Medicine) format, genomics, proteomics and text documents partitioned based on domain knowledge, and discharge summaries.

Structured data in a patient's record may not include a sufficient amount of data (e.g. to accurately diagnosis a patient), however, because much of the patient's medical information may be unstructured data. Despite recent efforts to include more structured data in a patient's record, records typically includes a larger amount of unstructured data because the unstructured data may be more easily acquired. For example, healthcare professionals (e.g. nurses and physicians) may be more comfortable with a narrative description (e.g. spoken) of the patients health than entering data into a computer.

Data in a patient record may include inconsistent data and the same or similar data (duplicate data) about the patient. Duplicate data and inconsistent data may occur from entry of information: (i) by the same or different people; (ii) at different times; (iii) using different modes of entry; and (iv) in different formats (e.g. structured fields and unstructured fields). For example, inconsistent data may include a portion (e.g. in a structured data field) of data indicating a patient is a smoker and another portion (e.g. unstructured data) indicating the patient is not a smoker. Duplicate data may occur if a triage nurse enters information of whether the patient is a smoker in a structured field and a floor nurse enters the same information into a progress note during care delivery. Duplicate data may also occur if the same or similar unstructured data (e.g. from narrative notes) is re-entered as structured data (e.g. in electronic fields).

Individuals (e.g. doctor) and/or entities (e.g. hospitals, insurance companies and regulatory bodies, such as Medicare) may rely on the accuracy of information in a patient medical record in their decision making. Inconsistent data received by an individual or entity may include inaccurate information, which may result in wrong diagnoses and/or treatments, harm to the patient and increased costs. Duplicate data, such as different portions data indicating a patient has been a smoker over time, may more accurately reflect a patient's current condition for numerous reasons, including accurate diagnoses and prescribing treatments.

Some entities, such as hospitals, may have reporting requirements for reporting patient medical data to organizations, such as federal organizations. These reporting requirements may further require evidence to support inconsistent and/or duplicate data being reported. Some conventional information technology systems (e.g. systems used by hospitals) merely try to structure the fields required for reporting from their unstructured data.

Some data (e.g. data indicating a patient's adverse reaction of procedures or tests, allergy or interaction with a drug) may be critical to a patient's safety. This critical data may be present in only unstructured format and may be inconsistent with structured data. Conventional order entry system modules may only incorporate the structured data, posing a risk to the patient's safety.

Accordingly, an improved system and method is needed for analyzing data in an electronic patient medical record.

### SUMMARY

Embodiments of the present invention are directed to a method of identifying information in electronic medical records that includes receiving one or more electronic medical records extracted from at least one source. Each of the one or more electronic medical records has medical information of at least one medical patient. The method also includes analyzing, via a processor, the medical information by comparing different portions of data in the medical information. The method further includes identifying, via the processor, at least one of: (i) the different portions of data in the medical information as inconsistent data; and (ii) the different portions of the data in the medical information as duplicate data.

According to one embodiment of the invention, the analyzing further includes comparing data that is associated with a first portion of the different portions of data to data that is associated with a second portion of the data. The identifying further includes identifying at least one of: (i) the data associated with the first and second portions of the medical data as inconsistent data; and (ii) the data associated with the first and second portions of the medical data as duplicate data.

According to another embodiment of the invention, the analyzing further includes determining data in a first portion of the different portions of data as data corresponding to one or more medical concepts, determining data in a second portion of the different portions of data as data corresponding to the one or more medical concepts, attributing a first value to the one or more medical concepts in the first portion, attributing a second value to the one or more medical concepts in the second portion and comparing the first value to the second value. The identifying further includes identifying at least one of: (i) the first value and the second value as inconsistent data; and (ii) the first value and the second value as duplicate data.

According to an aspect of the invention, the first value includes a first probability value of the one or more medical concepts occurring and the second value includes a second probability value of the one or more medical concepts occurring. According to another aspect of the invention, the attributing further includes attributing a nominal value or an ordinal value to each of the one or more medical concepts.

In one embodiment of the invention, the method further includes providing an alert responsive to the identifying of the at least one of: (i) the different portions of data in the medical information as inconsistent data; and (ii) the different portions of the data in the medical information as duplicate data.

In another embodiment of the invention, the receiving further includes receiving the extracted medical information from a group comprising computed tomography (CT) images, X-ray images, laboratory test results, doctor progress notes, medical procedures, prescription drug information, radiological reports, specialist reports, financial information, demographic information and billing information.

According to one embodiment of the invention, the method further includes storing domain-specific criteria in a domain knowledge base, combining the domain-specific criteria with the medical information in the one or more electronic medical records and analyzing the medical information using the domain-specific criteria.

According to another embodiment of the invention, the method further includes data mining the medical information from a first computerized patient record and a second computerized patient record using the domain-specific criteria in the domain knowledge base.

In another embodiment of the invention, the receiving further includes receiving electronic medical records from a plurality of sources.

According to an aspect of an embodiment of the invention, the plurality of sources comprise different medical entities.

In one embodiment of the invention, the receiving further includes receiving electronic medical records having structured data and unstructured data.

According to another embodiment of the invention, the method further includes converting the unstructured data into structured data prior to analyzing the medical information.

In an aspect of an embodiment, the method further includes accessing a database having a plurality of electronic medical records. Each medical record corresponds to one of a plurality of patients. The method further includes populating a plurality of data fields in the structured data with information corresponding to one of the plurality of patients.

According to one embodiment, the method further includes storing updated medical information corresponding to a disease of interest in a disease of interest database.

In one embodiment, the method is implemented on computer software that is readable and executable by a machine. In one aspect, the method is embodied in instructions stored on a non-transitory computer-readable medium.

Embodiments of the present invention are directed to a method of identifying data from a plurality of electronic patient data that includes selecting at least one electronic medical patient record comprising medical data of the medical patient, mining data from the at least one electronic medical patient record, compiling the mined data into at least one structured patient record and analyzing, via a processor, the mined data to identify at least one of: (i) inconsistent medical data from the mined data; and (ii) duplicate medical data from the mined data.

According to one embodiment, the analyzing further includes comparing first data that is associated with a first portion of the mined data to second data that is associated with a second portion of the mined data. The identifying further includes identifying at least one of: (i) the first data and the second data as inconsistent data; and (ii) the first data and the second data as duplicate data.

According to another embodiment, the analyzing further includes determining first data in a first portion of the mined data as corresponding to one or more medical concepts, determining second data in a second portion of the mined data as corresponding to the one or more medical concepts, attributing a first value to at least one of (i) the first data in the first portion; and (ii) the one or more medical concepts, attributing a second value to at least one of (i) the second data in the second portion; and (ii) the one or more medical concepts and comparing the first value to the second value to identify at least one of: (i) the first value and the second value as inconsistent data; and (ii) the first value and the second value as duplicate data.

In one embodiment, the mining includes using a domain knowledge base to scan the electronic patient record for a disease or condition of interest. In another embodiment, the analyzing to identify further includes matching any similar terms or phrases from the structured patient record.

According to another embodiment, the electronic patient record includes unstructured medical data. In one aspect, the electronic patient record includes structured medical data. In another aspect, the at least one electronic patient record comprises a plurality of electronic medical records. In yet another aspect, the plurality of electronic medical records originates from different sources.

In one embodiment, the method further includes selecting one electronic medical patient record. In one aspect, the method further includes selecting a plurality of electronic medical patient records. In another aspect, the method further includes identifying a plurality of medical patients.

In one embodiment, the method further includes providing an alert if any inconsistent and/or duplicate data is found.

In another embodiment, the method is embodied in instructions stored on a non-transitory computer-readable medium.

In one aspect, the method further includes identifying medical concepts and assigning at least one value to each concept. In another aspect of an embodiment, the method further includes locating all instances of a particular concept. In another aspect, the method further includes determining if the value of at least one concept is consistent for each instances of a particular concept.

Embodiments of the present invention are directed to a system for identifying information in electronic medical records that includes a data source. The data source includes at least one electronic patient medical record having patient medical data. The system also includes at least one extracting device configured to extract data from the patient medical data, a structured data source configured to include at least one of: (i) structured data extracted from the electronic patient medical record and (ii) unstructured data extracted from the electronic patient medical record and converted to structured data. The system further includes at least one system configured to analyze the structured data source for at least one of: (i) inconsistent data and (ii) duplicate data and at least one display for outputting the results of the analysis of the structured data source.

In one embodiment, at least a portion of the patient medical data is unstructured. In another embodiment, the system further includes a domain knowledge database.

According to one embodiment, the at least one system further includes a processor configured to analyze the structured data source. In another embodiment, the system further includes a module for analyzing the structured data source to identify the at least one of inconsistent data and duplicate data.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a block diagram of a computer processing system which may be used with embodiments disclosed herein;

FIG. 2 is a graphic illustration of an exemplary computerized patient record which may be used with embodiments disclosed herein;

FIG. 3 is a block diagram illustrating an exemplary data mining framework for mining high-quality structured medical information which may be used with embodiments disclosed herein;

FIG. 4 is a block diagram of an exemplary identification system which may be used with embodiments disclosed herein;

FIG. 5 is a system flow diagram illustrating a method of identifying data from a plurality of electronic patient data that can be used with embodiments disclosed herein; and

FIG. 6 is a system flow diagram illustrating a method of analyzing data and identifying data corresponding to a medical concept that can be used with embodiments disclosed herein.

### DETAILED DESCRIPTION OF ILLUSTRATIVE EMBODIMENTS

Embodiments of the present invention include systems and methods that identify duplicate information in patient medical records. Embodiments of the present invention also include systems and methods that identify inconsistent information in patient medical records. Other embodiments include systems and methods that identify duplicate information and inconsistent information in patient medical records. Embodiments of the present invention include data mining information from different sources and formats (e.g. structured and unstructured) to extract information from a patient's medical record, combining the information and analyzing the information to identify duplicate and/or inconsistent information. Embodiments of the present invention include presenting (e.g. displaying) the identified duplicate and/or inconsistent information and providing alerts to an individual or entity responsive to the identified duplicate and/or inconsistent information.

Embodiments of the present invention help to avoid mistakes, provide novices with knowledge captured from expert users based on a domain knowledge base of a disease of interest and established clinical guidelines, detect adverse events (e.g. during prescription of a medication to which the patient is allergic and the allergy information is only present in a clinical note) (see e.g., U.S. application Ser. No. 13/153,526, which is incorporated by reference in its entirety) and reconcile medications (present medications, discontinued medications, newly prescribed medications, etc.). Embodiments of the present invention may be used in quality reporting to regulatory bodies such as Centers for Medicaid and Medicare Services (CMS), verification of the accuracy of the reports, creating registries, business analytics, and the like.

Embodiments of the present invention may be used to assist with clinical trials. Embodiments of the present invention may also be used as a business intelligence tool. Embodiments of the present invention may be used to improve accuracy of order entry systems and aid in patient safety by comparing potions of unstructured data to other portions of unstructured data and/or comparing potions of structured data to other portions of unstructured data.

Embodiments of the present invention may be used to compare portions of inferential or implied data. For example, data may implicitly indicate a patient does not have a cardiovascular risk. A clinical summary may, however, include inconsistent data indicating that the patient is on statins (drugs for high cholesterol). Similarly, medical records of a patient may not include explicit mention of infection, but the medical data may implicitly indicate that the patient is taking antibiotics, which is a surrogate for infection.

Embodiments of the present invention may be implemented in various forms of hardware, software, firmware, special purpose processors, or a combination thereof. Preferably, embodiments of the present invention may be implemented in software as a program tangibly embodied on a program storage device. The program may be uploaded to, and executed by, a machine comprising any suitable architecture. Preferably, in some embodiments, the machine may be implemented on a computer platform having hardware such as one or more central processing units (CPU), a random access memory (RAM), and input/output (I/O) interface(s). The computer platform may also include an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that because, in some embodiments, constituent system components and method steps depicted in the accompanying figures may be implemented in software, the actual connections between the system components (or the process steps) may differ depending upon the manner in which the present invention is programmed.

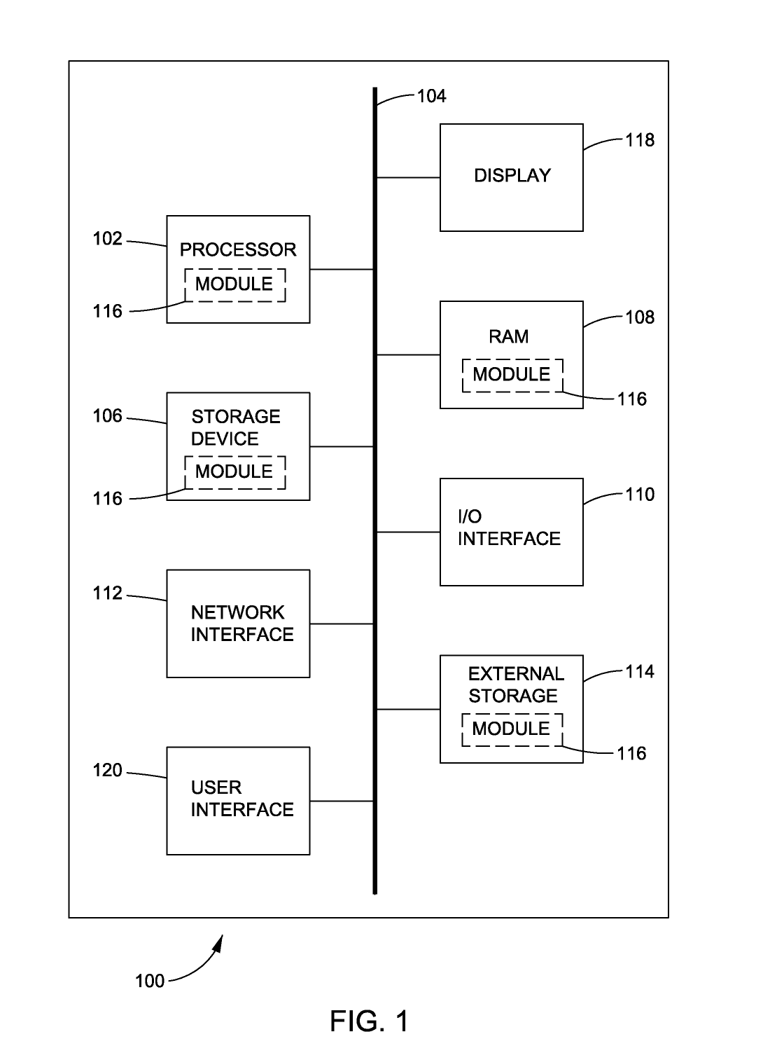

FIG. 1 is a block diagram of a computer processing system 100 to which the present invention may be applied according to an embodiment of the present invention. The system 100 includes at least one processor (hereinafter processor) 102 operatively coupled to other components via a system bus 104. A non-volatile storage device 106, a random access memory (RAM) 108, an I/O interface 110, a network interface 112, and external storage 114 may be operatively coupled to the system bus 104. Various peripheral devices such as, for example, a display device 118, a disk storage device (e.g., a magnetic or optical disk storage device), a keyboard and a mouse 120, may be operatively coupled to the system bus 104 by the I/O interface 110 or the network interface 112.

The computer system 100 may be a standalone system or be linked to a network via the network interface 112. The network interface 112 may be a wireless or hard-wired interface. In some embodiments, the network interface 112 may include any device suitable to transmit information to and from another device, such as a universal asynchronous receiver/transmitter (UART), a parallel digital interface, a software interface or any combination of known or later developed software and hardware. The network interface may be linked to various types of networks, including a local area network (LAN), a wide area network (WAN), an intranet, a virtual private network (VPN), and the Internet.

The computer system 100 may be a computer, personal computer, server, PACs workstation, imaging system, medical system, network processor, network, or other processing system. The computer system 100 may include at least one processor 102, a non-volatile storage device 106, a random access memory (RAM) 108, a network interface 112, an external storage device 114, an input/output (I/O) interface 110, a display 118, and a user input 120. The processor 102 may be operatively coupled to other components via bus 104. The processor 102 may be implemented on a computer platform having hardware components. Additional, different, or fewer components may be provided.

The external storage 114 may be implemented using a database management system (DBMS) managed by the processor 102 and residing on a memory such as a hard disk. In some embodiments, the external storage 114 may be implemented on one or more additional computer systems. For example, the external storage 114 may include a data warehouse system residing on a separate computer system. Those skilled in the art will appreciate that other alternative computing environments may be used without departing from the spirit and scope of the present invention.

The processor 102 may include a central processing unit, digital signal processor, application specific integrated circuit, field programmable gate array, digital circuit, analog circuit, combinations thereof, and the like for processing data. The processor 102 may include processing strategies, such as multiprocessing, multitasking, parallel processing, and the like.

The I/O 110, network interface 12, or external storage 114 may operate as an input operable to receive user data of a medical record. For example, the I/O interface 110 may be configured to receive user input via various input devices (e.g. keyboard, mouse, track ball, touch screen, joystick, touch pad, buttons, knobs, sliders, combinations thereof and the like). A stored file in a database may be selected in response to user input. In some embodiments, the processor 102 may automatically process newly entered user input, such as text.

The processor 102 may output a patient state, identified data and/or associated information on the display 118, into a memory, such as storage device 106, over a network via network interface 112, to a printer (not shown), or in another media. The state may provide an indication of whether a medical concept is indicated in the one or more patient records. The state may be whether a disease, condition, symptom, or test result is indicated.

The display 118 may be a text, graphical, combination thereof or other type display. The display may be a CRT, LCD, plasma, projector, monitor, printer, or other output device for showing data. The display 118 may be operable to output to a user a state associated with a patient, inconsistent data in one or more patient records and duplicate data in one or more patient records. In one embodiment, the state is limited to true and false, or true, false and unknown. In other embodiments, the state may be a level of a range of levels or other non-Boolean state.

The system 100 may include hardware devices, but may be implemented in various forms of hardware, software, firmware, special purpose processors, or a combination thereof. For example, the system 100 may include a tangible computer-readable memory that includes instructions for implementing the methods described herein, such as methods for identifying inconsistent and/or duplicate information. The tangible computer-readable memory may include a cache, buffer, RAM, removable media, hard drive or other computer readable storage media. For example, storage device 106 may be a tangible computer-readable memory that includes the program instructions that cause processor 102 to implement various methods described herein. In some embodiments, instructions may be stored on a local removable media device for reading by local or remote systems, such as in external storage device 114. In some embodiments, instructions may be stored in a remote storage location (not shown) such as a networked server or a cloud storage device and received via one or more communication ports, such as network interface 112 and I/O interface 110. The server may include a web server, a minicomputer, a mainframe computer, a personal computer, a mobile computing device, or other such device. The tangible, computer-readable memory 106 may include a collection of one or more devices, each having tangible computer-readable memory that stores data in a structured format, such as one or more databases, tables, or other computer-readable files. Processor 102 may include a single processor which implements the program instructions alone or may include multiple processors in a network or system for parallel or sequential processing.

The same or different computer readable media may be used for the instructions, the individual patient text passages, and the labeled text passages (training data). The patient records may be stored in one or more external storage devices, such as external storage 114. The external storage 114 may be implemented using a database management system (DBMS) managed by the processor and residing on a memory, such as a hard disk, RAM, or removable media. Alternatively, storage 114 is internal to the processor (e.g. cache). The external storage 114 may be implemented on one or more additional computer systems (not shown). For example, the external storage 114 may include a data warehouse system residing on a separate computer system, such as a PACS system, or any other system used by a hospital, medical institution, medical office, testing facility, pharmacy or other medical patient record storage system. The external storage 114, internal storage 106 other computer readable media, or combinations thereof may store data for at least one patient record for a patient. The patient record data may be distributed among multiple storage devices.

The processor 102 may perform the workflow, machine learning, model training, model application, and/or other processes described herein. For example, the processor 102 or a different processor (not shown) may be operable to extract terms for use in modeling and applying a learned probability model. For applying the model, the model may have been trained by a different processor or the same processor.

The computer system 100 may also include an operating system (not shown) and microinstruction code. The various methods described herein may be part of the microinstruction code or part of a program (or combination thereof) which is executed via the operating system.

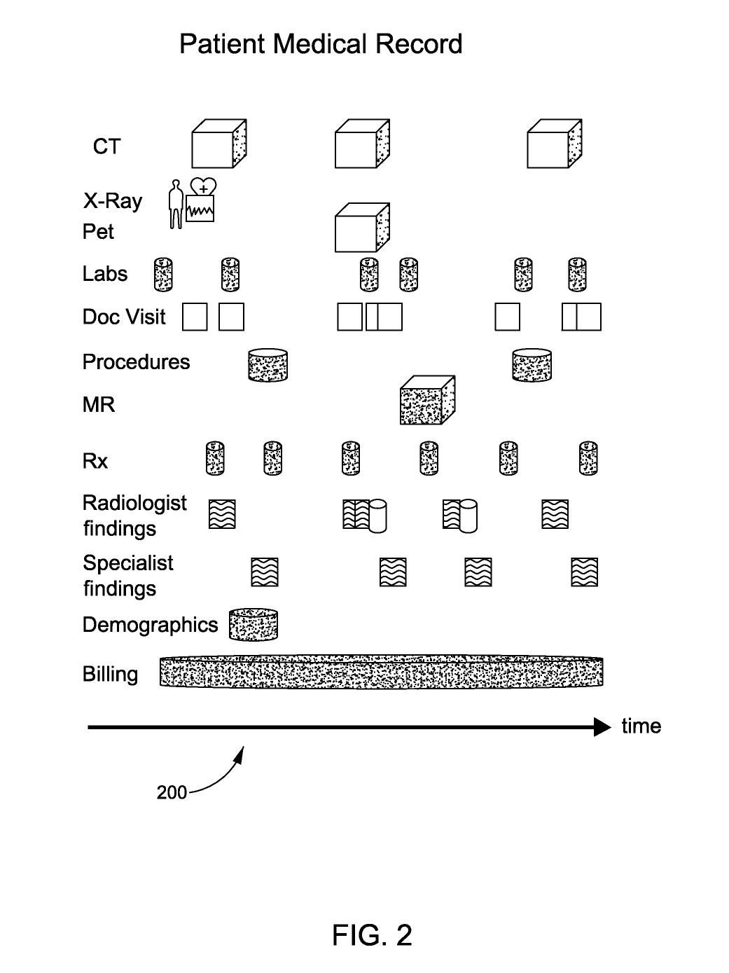

In some embodiments, a computerized patient record (CPR) may be used to store patient information. As shown in FIG. 2, an exemplary CPR 200 may include information that is collected over the course of a patient's treatment. This information may include, for example, computed tomography (CT) images, X-ray images, laboratory test results, doctor progress notes, details about medical procedures, prescription drug information, radiological reports, other specialist reports, demographic information, and billing (financial) information.

A CPR, such as CPR 200 may include information from a plurality of data sources (e.g. imaging and non-imaging sources), each of which may reflect a different aspect of a patient's care. Some data sources may include only structured data, such as financial, laboratory, and pharmacy databases, generally maintain patient information in database tables. Other data sources may include only unstructured data, such as, for example, free text, images, and waveforms, natural language information from a medical professional, ASCII text strings, image information in DICOM (Digital Imaging and Communication in Medicine) format, and text passages. Text passage may include a sentence, group of sentences, paragraph, group of paragraphs, a document, a group of documents, or combinations thereof. In some embodiments, data sources may include a combination of structured data and unstructured data.

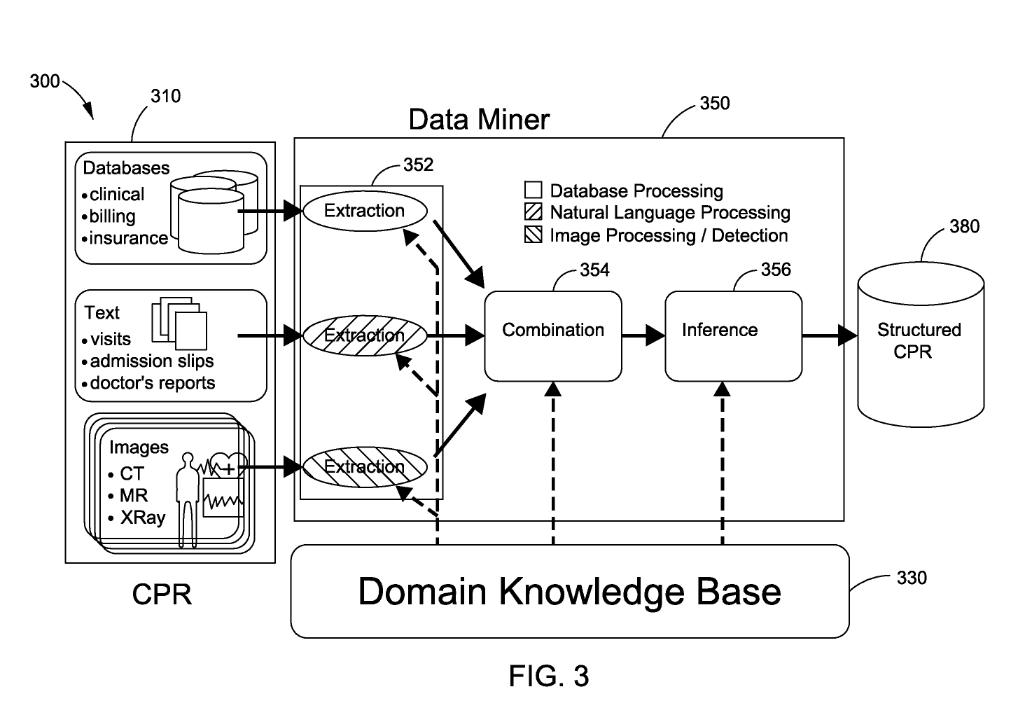

FIG. 3 illustrates an exemplary data mining system 300 for mining medical information using data mining techniques for use with some embodiments of the invention. As shown at FIG. 3, the data mining system 300 may include a data miner 350 that extracts medical information from CPR 310 using domain-specific knowledge contained in a knowledge base 330. Domain-specific criteria, which may be included in on or more data bases, such as domain knowledge base 330, may include data available at a hospital, document structures at a hospital, policies of a hospital, guidelines of a hospital and any variations of a hospital. The domain-specific criteria may also include disease-specific domain knowledge. For example, the disease-specific domain knowledge may include various factors that influence risk of a disease, disease progression information, complications information, outcomes and variables related to a disease, measurements related to a disease and policies and guidelines established by medical bodies.

The medical information may be mined from different sources (e.g. different systems), which may have different IP addresses and/or physical addresses and locations. In some embodiments, the medical information may be mined from a plurality of electronic medical records for a particular patient or set of patients. The medical information may be also be mined from one or more records having different formats (e.g. structured format versus unstructured format and scanned images versus text). For example, data in the medical records for a patient may be in an unstructured format, such as a physician's free text notes taken during the patient's visits. Data in the medical records may also be in a structured format such as questions, answers and explanations in electronic fields that have been provided by an individual (e.g. a patient, a nurse, a doctor).

The data miner 350 may include components 352 for extracting information from data sources, such as sources in CPR 310 to create a set of probabilistic assertions, a combination component 354 for combining the set of probabilistic assertions to create one or more unified probabilistic assertion, and an inference component 356 for drawing inferences from this combination process such as inferring patient states from the one or more unified probabilistic assertion. The extraction component 352 may extract pieces of information from each data source regarding a patient, which are represented as probabilistic assertions (elements) about the patient at a particular time. The combination component 354 may combine each of the elements that refer to the same variable at the same time period to form one unified probabilistic assertion (factoids) regarding that variable. The inference component 356 receives these factoids at the same point in time and/or at different points in time to produce a coherent and concise picture of the progression (state sequence) of the patient's state over time. Embodiments of the present invention may build an individual model of the state of a patient. The patient state may include a collection of variables relating to the patient. The information of interest may include a state sequence (i.e., the value of the patient state at different points in time during the patient's treatment).

Each of the above components may use detailed knowledge regarding a domain of interest that is included in one or more domain knowledge bases, such as domain knowledge base 330. The domain knowledge base 330 may include domain-specific criteria specific to a condition of interest (e.g. a disease such as cancer, symptoms and whether the patient is a smoker), billing information and institution-specific knowledge. The domain knowledge base 330 may be encoded as an input to the system or as programs that produce information that can be understood by the system. The part of the domain knowledge base 330 that is input to the present form of the system may also be learned from data. The extraction component 352 may produce elements about the patient with the guidance of the domain knowledge that is contained in the domain knowledge base 330. The domain knowledge required for extraction may be specific to each source.

As described above, medical information may be also be mined from one or more records having an unstructured format. In some embodiments, the domain knowledge base 330, which may include a list of disease-associated terms and/or medical concepts, may mine for corresponding information from a medical record. The domain knowledge base 330 may automatically mine this corresponding information where the mining is based on probabilistic modeling and reasoning. For example, for a medical concept such as heart failure, the processor 102 may automatically determine the probability of whether heart failure has occurred in the patient based on a transcribed text passage.

In some embodiments, a probabilistic methodology may be used to infer the state of the patient. For example, as described in U.S. Pat. No. 7,840,511, which is incorporated by reference in its entirety, a probabilistic model takes into account the statistics of words or words and their relationship to patient states and conditions. Known and unknown variables may influence the meaning of a sentence and the relationship of the known and unknown variables and their combined effect may not be deterministic of the meaning of a sentence. Medical concepts may not be easily inferred from words or phrases alone, such as in phrase spotting, because the language employed may be complex and unstructured from a computational perspective.

The mined information may be stored in a structured CPR database 380. Structured CPR database 380 may include structured data and unstructured data converted into a structured format. In some embodiments, after the unstructured data is extracted from the medical records, the unstructured data may be provided directly to processing system 100 without being stored in structured CPR database 380.

In some embodiments of the present invention, the data miner may operate via a wired or wireless communications network, such as a local area network, a wide area network, an intranet, the Internet or another network. In some embodiments, structured clinical information may also be accessed using a wired or wireless communications network. The system 100 may be run at arbitrary intervals, periodic intervals and in online mode. When system 100 is run at intervals, the data sources in CPR 310 may be mined only when the system 100 is running. In online mode, the data sources in CPR 310 may be continuously mined.

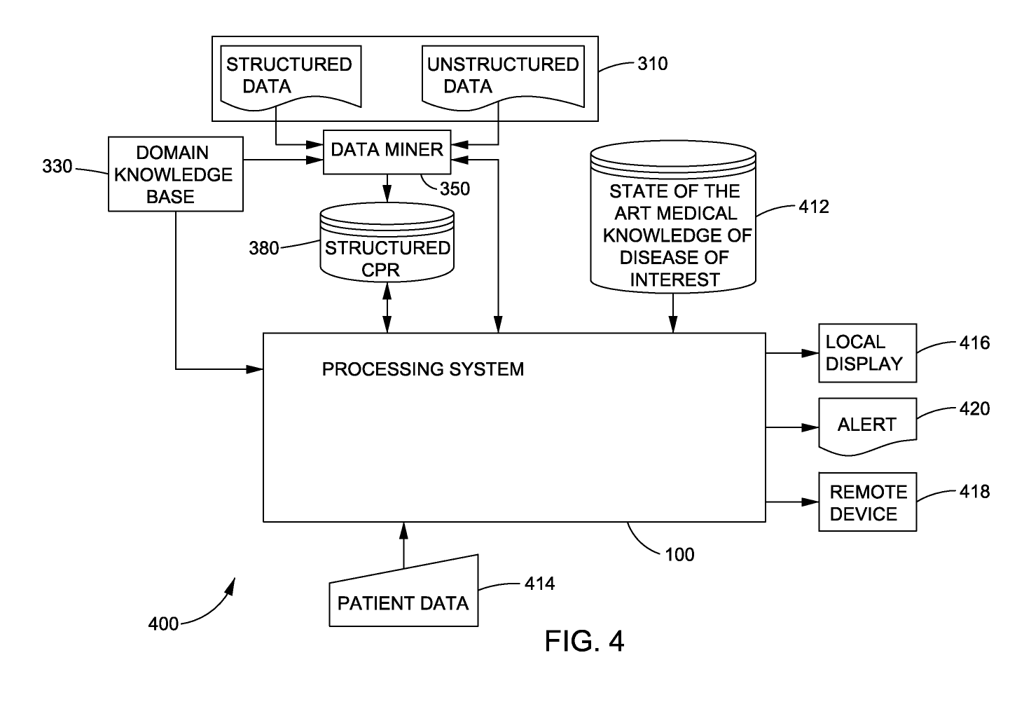

FIG. 4 is an exemplary identification system 400 for identifying inconsistent and/or duplicate information according to embodiments of the present invention. As shown at FIG. 4, the identification system 400 may include a data base such as CPR 310 having both structured and unstructured data. Exemplary identification systems may include a database, such as CPR 310, having one or more electronic medical records of a medical patient. Exemplary identification systems may also include a database or a plurality of data bases having one or more electronic medical records of multiple medical patients. The identification system 400 may also include an extraction device, such as data miner 350, a domain knowledge base 330 having domain-specific criteria. Identification system 400 may further include a processing system, such as computer processing system 100 (shown at FIG. 1) for processing medical information, analyzing the medical information and identifying inconsistent data and/or duplicate data in the medical information. Exemplary identification systems may also include a plurality of processing systems.

Processor 102 of processing system 100 may extract information from the structured CPR database 380, for identifying inconsistent and/or duplicate information about a patient. The processor 102 may be also be coupled to data miner 350, a disease of interest database 412 that includes updated information relating to a disease of interest and domain knowledge base 330. The information in disease of interest database 412 may include standard procedures, established guidelines for treatments, standardized tests for assessment. The information in disease of interest database 412 may also be included in the domain knowledge base 330. The processor 102 may be further coupled to other databases having additional data. In some embodiments, processing system 100 may include an extraction device, separate from processor 102 that extracts information from at least one of the structured CPR database 380, data miner 350, domain knowledge base 330 and disease of interest data base 412.

The processor 102 may be adapted to receive manually inputted patient data 414 to process and store in the structured database 380. Each task performed by the processing system 100 may be performed by an executable module 116, shown at FIG. 1, residing either in the processor 102 of the processing system 100 and/or in a memory device, such as storage device 106, RAM 108 and external storage 114, etc.) of processing system 100. In some embodiments, diagnosis and projection system 400 may include a plurality of processing systems 100.

Identification system 400 may also include at least one display, such as local display 416. Identification system 400 may also include at least one remote device 418, which may include any remote device configured to receive identified duplicate and/or inconsistent data, such as a computer, router, display, printer and handheld device. The identified duplicate and/or inconsistent data may be output via network interface 112. Processing system 100 may also be configured to provide an alert 420. The alert 420 may be a visual alert (e.g. light, blinking light, words or image on a display) or an audio alert.

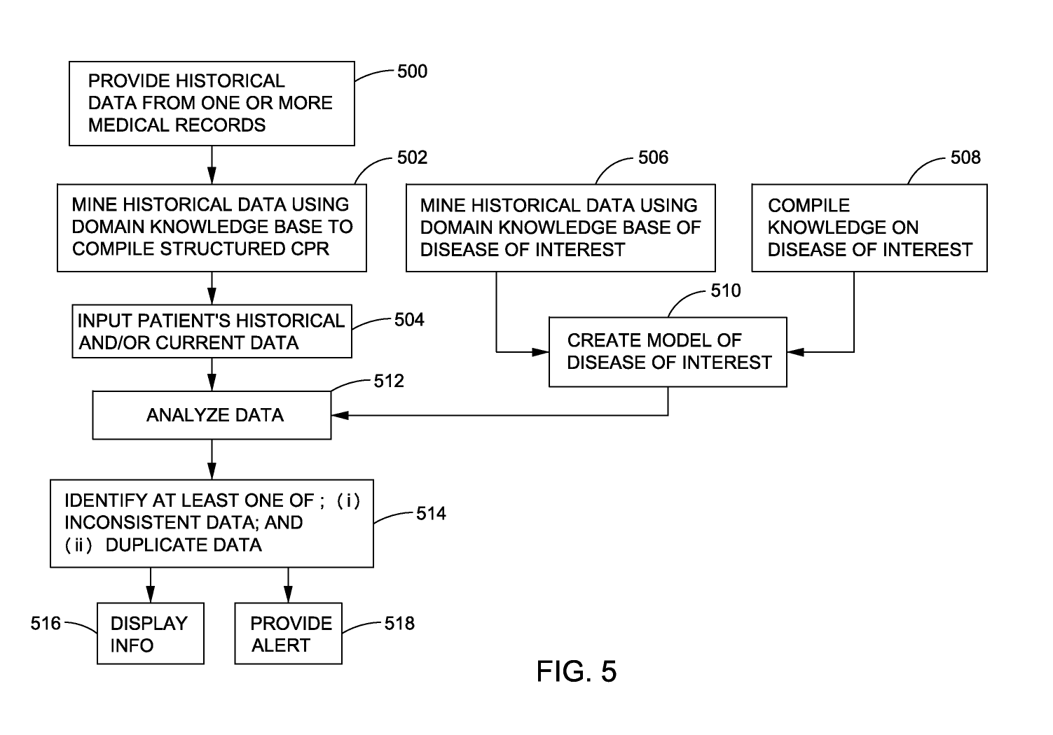

Referring to FIGS. 4 and 5, the identification system 400 will be further described along with methods for identifying inconsistent and/or duplicate information about a patient and providing at least one alert in response to the identified inconsistent and/or duplicate information. First, as shown in the embodiment at FIG. 4, medical information in patient medical record 310 is assembled during the course of treatment of a patient over time. In some embodiments, medical information for a medical patient may be assembled from more than one patient medical record. Additionally, a plurality of patient records for different patients (i.e., population-based data) may be assembled for a particular hospital and stored in common data storage area as the individual patient record 310. Referring to FIG. 5, at block 500, one or more electronic medical records each having medical information of at least one medical patient may be provided to the system 400. At block 502, the medical information (historical data) from the one or more electronic medical records may be mined using domain-specific criteria in a domain knowledge base relating to a disease of interest and compiled in a structured CPR database 380. For example, the patient's historical data may be extracted from CPR 310 via data miner 350.

At block 504, one or more portions of the patient's current data may be manually inputted into the processing system 100, as shown at block 414 at FIG. 4, and one or more portions of the patient's historical data from structured CPR 380 may be automatically inputted into the processing system 100. The mined data inputted into the processing system 100 may be data stored in structured CPR database 380. The mined data inputted into the processing system 100 may also be provided directly from data miner 350 without being stored in structured CPR database 380. In some aspects, portions of the mined data may be inputted to processing system 100 one at a time. In other aspects, portions of the mined data may be simultaneously inputted to processing system 100.

Data mining may be performed by the REMIND™ system, which is shown and described in U.S. Pat. Nos. 7,617,078, 7,181,375, 7,744,540, 7,457,731 and 7,840,511, as well as, U.S. patent application Ser. Nos. 10/287,075, 10/287,098, 10/287,054, 10/287,329, 10/287,074, 10/287,073, 11/435,660, 11/435,657, 11/758,716, 12/488,083, 12/780,012, 10/319,365, and 12/190,675, which are all incorporated herein by reference in their entirety.

A model may be created to simulate a patient with similar characteristics of the patient being diagnosed. The processor 102 may generate data for the model by mining data of similar patients from population-based data sources via data miner 350 using a domain knowledge base 330 of the disease of interest at block 506. The processor 102 may then create the model of the disease of interest based on the mined data at block 510. Additionally, the processor may compile knowledge on the disease of interest from the second medical knowledge database 412 at block 508 and refine the model with this knowledge. After the patient model is created, all available patient data (e.g. data mined from structured and unstructured sources and/or manually input), may be entered into the model and various simulations may be run.

At block 512, the medical information may be analyzed by processor 102. At block 514, the analyzed data may be identified by processor 102 as inconsistent data and/or duplicate data. For example, in some embodiments, processing system 100 may interpret data (e.g. words and terms) in different portions of the mined medical data via algorithms (e.g. natural language algorithms) and convert unstructured data to salient pieces of information in structured data fields. Mined data of a patient's medical record may be analyzed at different levels (e.g. sentence, paragraph, document and patient record). A portion of the mined medical data may then be compared to another portion of the mined medical data to determine and/or identify inconsistent data and/or duplicate data. Portions may include an ASCII character, a number of ASCII characters, a field, a word, a term, a group of words, a sentence, a paragraph and a document. For example, the term smoker in one portion of the mined medical data may be compared to the term non-smoker in the same (e.g. same sentence) or another portion (e.g. different document) of the mined medical data.

In other embodiments, data that is associated with a first portion of the mined medical data may be compared to data associated with a second portion of the mined medical data to identify data as inconsistent and/or duplicate data. In some aspects, data that is associated with a portion of the mined medical data may include medical concepts corresponding to the mined medical data. The data corresponding to the medical concepts and/or the corresponding medical concepts may then be compared to identify the data as inconsistent and/or duplicate data. Medical concepts may include any medical concepts such as congestive heart failure, cardiomyopathy, cancer, smoking or any intervention. Medical concepts may be concepts included in domain knowledge base 330, disease of interest data base 412 and any other database, such as a medical ontology database. The determination of a medical concept existing at one level (e.g. sentence) may be used to determine whether the medical concept exists at a higher or more comprehensive level (e.g., paragraph, document, or patient record). It is also contemplated that information that is associated with the mined medical data may include types of data other than medical concepts that may be compared to identify the data as inconsistent and/or duplicate data.

For example, processing system 100 may identify data stored in the structured CPR 380 as corresponding to a medical concept. The medical concept may be received from one or more data bases, such as domain knowledge base 330, disease of interest data base 412 or another database (e.g. a medical ontology database). In some aspects, information that is associated with the mined medical data may include values (e.g. labels, as described in U.S. Pat. No. 7,840,511, which is incorporated herein by reference in its entirety) attributed to the mined information. For example, information that is associated with the mined medical data may include values assigned to the medical concepts. At least one value may be attributed to each of the one or more medical concepts. A value may be generated for a medical concept (e.g. smoker=yes) if the patient's medical record includes doctor's notes indicating that the person is a smoker. Processing system 100 may also generate a different value for the medical concept (e.g. smoker=no) if the patient has more recently indicated (e.g. in a questionnaire) that he/she is not a smoker because the patient has recently quit smoking, resulting in inconsistent data in the patient's medical record. The first value “yes” attributed to the concept “smoker” and the second value “no” attributed to the concept smoker may then be compared to identify the data in the first and second portions as inconsistent data. Embodiments may include a variety of other medical concepts, such as allergies or an allergy to a medication.

The values attributed to one or more medical concepts may also be compared to determine duplicate data. For example, processing system 100 may generate a value for a medical concept (e.g. smoker=no) if the patient's medical record includes doctor's notes indicating that the person is not a smoker. Processing system 100 may also generate a duplicate value for the medical concept (e.g. smoker=no) if the patient has more recently indicated (e.g. in a questionnaire) that he/she is not a smoker. The first value “no” attributed to the concept “smoker” and the second value “no” attributed to the concept smoker may then be compared to identify the data in the first and second portions as duplicate data.

Different types of values (e.g. nominal value or an ordinal value) may be assigned to each medical concept. Boolean functions (e.g. true and false) or any discrete set of three or more options (e.g., large, medium and small) may be used to indicate whether a medical concept exists in a patient's medical record. A neutral state (e.g. unknown state) may also be used if the existence of a medical concept in a patient's medical record is unclear or unknown.

In some embodiments, the medical records may be analyzed by processing system 100 to determine whether at least one of the medical concepts occurs more than once in a patient's medical record. For example, values may be assigned to a first occurrence of a medical concept and a second occurrence of the medical concept. Processing system 100 may then determine whether the values assigned to the first occurrence and the second occurrence are the same.

In some embodiments, data based on a probability model may be analyzed by processing system 100 to identify inconsistent data and/or duplicate data. One or more medical concepts in a patient's medical record may be identified, probability values may be attributed to the one or more medical concepts and the probability values may be identified as being inconsistent data and/or duplicate data. For example, processor 102 may receive data (e.g. a statement in a doctor's note) from patient's medical record indicating that the patient has cancer. A Boolean value and a probability value (e.g. (i) cancer=true and probability=0.9; and/or (ii) cancer=unknown and probability=0.1) based on the statement may be attributed to a medical concept (e.g. cancer). In some embodiments, probability values may be manually input. In some embodiments, processing system 100 may determine and assign the probability value based on the statement indicating that the patient has cancer. [HOW IS THIS PROBABILITY OF 0.9 DETERMINED BY THE PROCESSOR? WHAT ARE ALL OF THE EMBODIMENTS FOR DETERMINING THE PROBABILITY BASED ON THE STATEMENT?] Processing system 100 may also determine and attribute a probability value from a base probability value (e.g. (i) cancer=true and probability=0.35; and/or (ii) cancer=false and probability=0.65) for patients in a patient sample. That is, the base probability value may be based on a patient sample indicating 35% of patients in the patient sample have cancer. Processing system 100 may further determine a combined probability value (e.g. (i) cancer=true and probability=0.93; and (ii) cancer=false and probability=0.07) from both the base probability and the probability value concluded from the statement by the doctor.

Processing system 100 may determine other data in the patient's medical record or another medical record indicating a different probability value of the patient having cancer. For example, processing system 100 may determine other data indicating cancer=false and probability=0.7. The different probability values may then be compared to determine and identify the data as inconsistent data. [WHAT OTHER TYPES OF INFORMATION ASSOCIATED WITH THE MEDICAL DATA (BESIDES VALUES OF MEDICAL CONCEPTS) MAY BE COMPARED TO IDENTIFY INCONSISTENT AND/OR DUPLICATE DATA?]

The probability model may be applied to any data (e.g. text passage of the medical transcript) in any format (e.g. structured and non-structured) of a patient's medical record. Key terms may be identified in the data, such as identifying a discrete set of terms as elements identified as a function of mutual information criteria. The key terms may be associated with learned statistics of words or phrases relative to the state of the medical concept of interest. Based on the statistics for conditional and prior probability functions of words or phrases relative to the state or a learned model, a state with a highest probability given the terms identified in the text passage may be determined. In one embodiment, negation and/or modifier terms may be identified and input to the model separately from the key terms of a medical concept. A Bayes or other model, having a summary node for the text passage, a negation node, and a modifier node, may be used. The state may be inferred as a function of an output from the probabilistic model applied to the text passage.

Based on the application of the probabilistic model, the processor 102 may output a state for the patient. The state may be a most likely state. A plurality of states associated with different medical concepts may be output. A probability associated with the most likely state may be output. A probability distribution of likelihoods of the different possible states may be output. The processor 102 may output a state for the patient based on the application of the probabilistic model. In some embodiments, the state (e.g. patient has cancer) of the patient may be determined from one or more medical concepts in the data (e.g. text) of one patient's records. In other embodiments, the state of the patient may be determined from one or more medical concepts in the data (e.g. text) of the records of multiple patients. It is contemplated that multiple states of a patient may be determined. In some aspects, the most probable medical concept and corresponding state may be identified.

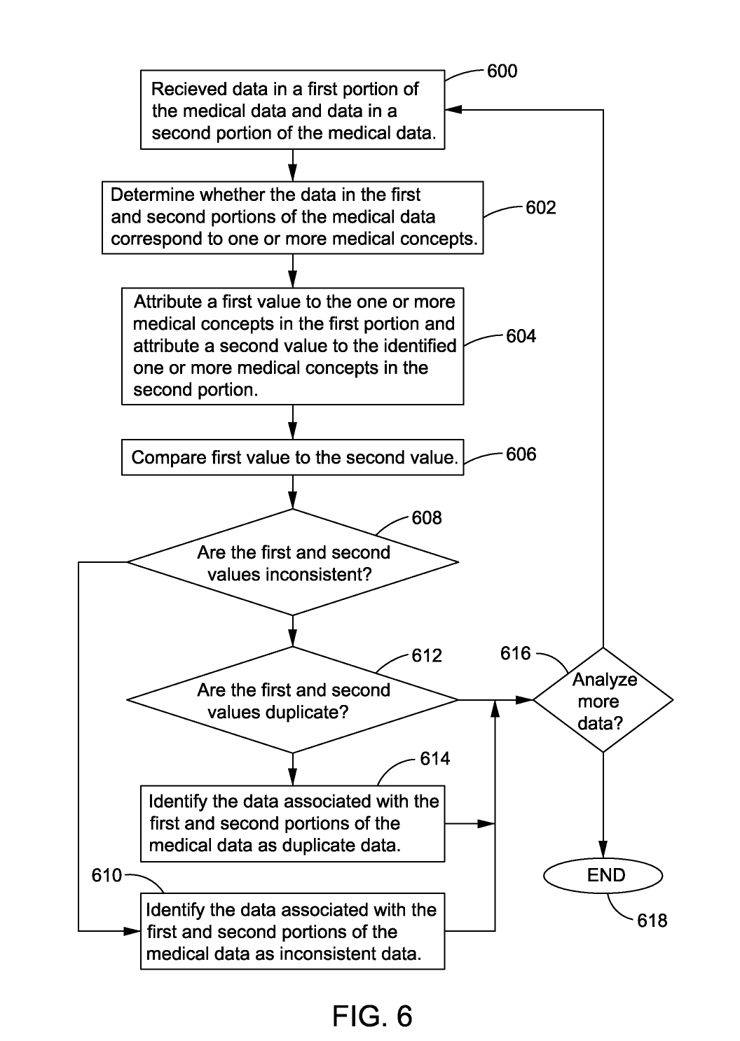

As described above, data that is associated with a first portion of the mined medical data (e.g. one or more medical concepts) may be compared to data associated with a second portion of the mined medical data to identify data as inconsistent and/or duplicate data. FIG. 6 is a system flow diagram illustrating an exemplary method of analyzing and identifying data corresponding to one or more medical concepts that can be used with embodiments disclosed herein. At block 600, processing system 100 may receive data in a first portion of the medical data and data in a second portion of the medical data from structured CPR 380. In some embodiments, data in more than two portions may be received from structured CPR 380 to analyze.

At block 602, data in the first portion of the medical data may be determined as corresponding to one or more medical concepts and data in the second portion of the medical data may be determined as corresponding to the one or more medical concepts. For example, a medical concept may include the term “smoker.” If the patient's medical record includes doctor's notes (a first portion) indicating that the person is a smoker, the term “smoker” may be determined as corresponding to the medical concept smoker. If the patient has more recently indicated in a questionnaire (a second portion) that he/she is not a smoker because the patient has recently quit smoking, the terms “not a smoker” may be determined as corresponding to the medical concept smoker.

At block 604, a first value may be attributed to the one or more medical concepts in the first portion and a second value may be attributed to the identified one or more medical concepts in the second portion. For example, processing system 100 may attribute a first value “yes” to the medical concept “smoker,” resulting in “smoker=yes” because the first portion of the patient's medical record includes doctor's notes indicating that the person is a smoker. Processing system 100 may also attribute a second value “no” for the medical concept “smoker,” resulting in “smoker=no” because the second portion of the patient's medical record indicates that the person has recently quit and is not a smoker. In this embodiment, the attributed values are Boolean values. In other embodiments, other values, such as probability values, may be attributed to one or more medical concepts. Further, more than value may be attributed to a medical concept. For example, both Boolean and probability values (e.g. cancer=true and probability=0.9) may be attributed to the medical concept “cancer.”

At block 606, the first value may be compared to the second value. For example, the first value “yes” attributed to the concept “smoker” and the second value “no” attributed to the concept smoker may then be compared. At decision point 608, processing system 100 may determine whether the first value and the second value are inconsistent data. For example, processing system 100 may determine that the first value “yes” attributed to the concept “smoker” and the second value “no” attributed to the concept smoker are inconsistent data. Accordingly, at block 610, processing system 100 may identify the data associated with the first portion (smoker=yes) and the data associated with the second portion (smoker=no) of the medical data as inconsistent data. Processing system 100 may then determine, at decision point 616, whether to continue analyzing data at different portions in the structured database 380. In some aspects, the decision of whether to analyze additional data may be automatic, responsive to one or more portions of additional data being automatically or manually inputted to processing system 100. In some aspects, the decision may be responsive to an instruction to continue to analyze additional data. As shown at FIG. 6, processing system 100 may determine, at block 616, to analyze more data by returning to block 600 to receive more data and then proceed to block 602 to again determine whether data in first and second portions of data correspond to one or more medical concepts. In some embodiments, processing system 100 may not proceed to block 602, but alternatively proceed to compare the data in the first and second portions of the medical data without determining whether data in the first and second portions correspond to one or more medical concepts.

If the first value and the second value are determined, at decision point 608, not to be inconsistent data (e.g. the first value is smoker=no and the second value smoker=no), then processing system 100 may determine, at decision point 612, whether the first value and the second value are duplicate data. In the embodiment shown at FIG. 6, the determination of whether data is inconsistent data and the determination of whether data is duplicate data is shown as being processed in series. In other embodiments, the determination of whether data is inconsistent data and the determination of whether data is duplicate data may be processed in parallel circuits. In some embodiments, a processor may simultaneously analyze data in a plurality of different portions of the medical data. In some embodiments, a plurality of processors may be used to analyze the data in a plurality of different portions of the medical data.

If processing system 100 determines, at decision point 612, that the first value “no” attributed to the concept “smoker” and the second value “no” attributed to the concept smoker are duplicate data, processing system 100 may identify the data associated with the first portion (smoker=no) and the data associated with the second portion (smoker=no) as duplicate data. Processing system 100 may then determine, at decision point 616, whether to continue analyzing data at different portions in the structured database 380.

Processing system 100 may also determine that exemplary first and second values attributed to information associated with data at first and second portions of the structured data base 380 are neither inconsistent nor duplicate. Processing system 100 may make the determination for both the first and second values simultaneously or one at a time in any order. For example, processing system 100 may determine that exemplary first and second values are not inconsistent data at decision point 608 and not duplicate data at decision point 612. Processing system 100 may then determine, at decision point 616, whether to continue analyzing data at different portions in the structured database 380.

Referring to FIG. 5, the identified inconsistent data and/or duplicate data in the medical information may be presented to an individual or entity. For example, as shown at block 516, identified inconsistent data and/or duplicate data may be displayed on a local display 118 or remote display via network interface 114 and/or I/O interface 110.

As shown at block 518, the system may provide an alert 420 responsive to the identified inconsistent data and/or duplicate data. The alert may be aural or provided on a display to an individual or entity via network interface 114 and/or I/O interface 110. The alert may indicate the identified inconsistent data and/or duplicate data. For example, processing system 100 may provide an audial alert to a remote computer (not shown) via network interface 114. The alert may also be displayed on a local display 416 via I/O interface 110 indicating the inconsistent data and/or duplicate data that has been identified. In some embodiments, processing system 100 may determine an individual or entity capable of investigating and/or correcting the inconsistent information and alert the determined individual regarding the identified inconsistent data and/or duplicate data. Identified inconsistent data and/or duplicate data may then be presented to a healthcare provider or other personnel in the healthcare facility in order to take corrective actions. The alert may be performed in real time as well as in a retrospective manner. As more information about a patient is input into the system (either structured or unstructured), the system may dynamically mine the existing data for the respective patient and provide alerts regarding additional inconsistent data and/or duplicate data. This additional inconsistent data and/or duplicate data may also be presented to the user who has a choice of either correcting the data being input or the existing information, adding some information about the inconsistency or simply ignoring the alert. As a retrospective analysis, the system can be used to identify inconsistent information for a single patient or a batch of patients and individuals can then take necessary actions.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A method of identifying information in electronic medical records, the method comprising:
receiving one or more electronic medical records extracted from at least one source, each of the one or more electronic medical records having medical information of at least one medical patient;
analyzing, via a processor, the medical information by comparing different portions of data in the medical information; and
identifying, via the processor, at least one of: (i) the different portions of data in the medical information as inconsistent data; and (ii) the different portions of the data in the medical information as duplicate data.

2. The method of claim 1, wherein:
the analyzing further comprises comparing data that is associated with a first portion of the different portions of data to data that is associated with a second portion of the data, and
the identifying further comprises identifying at least one of: (i) the data associated with the first and second portions of the medical data as inconsistent data; and (ii) the data associated with the first and second portions of the medical data as duplicate data.

3. The method of claim 1, wherein:
the analyzing further comprises:
determining data in a first portion of the different portions of data as data corresponding to one or more medical concepts and determining data in a second portion of the different portions of data as data corresponding to the one or more medical concepts;
attributing a first value to the one or more medical concepts in the first portion and attributing a second value to the one or more medical concepts in the second portion;
comparing the first value to the second value, and
the identifying further comprises identifying at least one of: (i) the first value and the second value as inconsistent data; and (ii) the first value and the second value as duplicate data.

4. The method of claim 3, wherein the first value includes a first probability value of the one or more medical concepts occurring and the second value includes a second probability value of the one or more medical concepts occurring.

5. The method of claim 1, further comprising providing an alert responsive to the identifying of the at least one of: (i) the different portions of data in the medical information as inconsistent data; and (ii) the different portions of the data in the medical information as duplicate data.

6. The method of claim 1, further comprising:
storing domain-specific criteria in a domain knowledge base;
combining the domain-specific criteria with the medical information in the one or more electronic medical records; and
analyzing the medical information using the domain-specific criteria.

7. The method of claim 1, further comprising data mining the medical information from a first computerized patient record and a second computerized patient record using the domain-specific criteria in the domain knowledge base.

8. The method of claim 1, wherein the receiving further comprises receiving electronic medical records from a plurality of sources.

9. The method of claim 1, wherein the receiving further comprises receiving electronic medical records having structured data and unstructured data.

10. The method of claim 1, further comprising converting the unstructured data into structured data prior to analyzing the medical information.

11. The method of claim 10, further comprising:
accessing a database having a plurality of electronic medical records, each medical record corresponding to one of a plurality of patients; and
populating a plurality of data fields in the structured data with information corresponding to one of the plurality of patients.

12. A method of identifying data from a plurality of electronic patient data, the method comprising:
selecting at least one electronic medical patient record comprising medical data of the medical patient;
mining data from the at least one electronic medical patient record;
compiling the mined data into at least one structured patient record; and
analyzing, via a processor, the mined data to identify at least one of: (i) inconsistent medical data from the mined data; and (ii) duplicate medical data from the mined data.

13. The method of claim 12, wherein:
the analyzing further comprises comparing first data that is associated with a first portion of the mined data to second data that is associated with a second portion of the mined data, and
the identifying further comprises identifying at least one of: (i) the first data and the second data as inconsistent data; and (ii) the first data and the second data as duplicate data.

14. The method of claim 13, wherein the electronic patient record comprises unstructured medical data and the comparing further comprises comparing the first data mined from the unstructured medical data to the second data mined from the unstructured medical data.

15. The method of claim 13, wherein the electronic patient record comprises structured medical data and unstructured medical data and the comparing further comprises comparing the first data mined from the structured medical data to the second data mined from the unstructured medical data.

16. The method of claim 12, wherein:
the analyzing further comprises:
determining first data in a first portion of the mined data as corresponding to one or more medical concepts and determining second data in a second portion of the mined data as corresponding to the one or more medical concepts;
attributing a first value to at least one of (i) the first data in the first portion; and (ii) the one or more medical concepts;
attributing a second value to at least one of (i) the second data in the second portion; and (ii) the one or more medical concepts; and
comparing the first value to the second value to identify at least one of: (i) the first value and the second value as inconsistent data; and (ii) the first value and the second value as duplicate data.

17. A system for identifying information in electronic medical records, the system comprising:
a data source comprising at least one electronic patient medical record having patient medical data;
at least one extracting device configured to extract data from the patient medical data;
a structured data source configured to include at least one of (i) structured data extracted from the electronic patient medical record and (ii) unstructured data extracted from the electronic patient medical record and converted to structured data;
at least one system configured to analyze the structured data source for at least one of: (i) inconsistent data and (ii) duplicate data; and
at least one display for outputting the results of the analysis of the structured data source.

18. The system of claim 17, wherein at least a portion of the patient medical data is unstructured.

19. The system of claim 17, further comprising a domain knowledge database.

20. A tangible computer readable medium comprising instructions for causing a computer to implement the steps of:
receiving medical information of at least one medical patient from at least one source,
analyzing the medical information by comparing different portions of data in the medical information; and
identifying at least one of: (i) the different portions of data in the medical information as inconsistent data; and (ii) the different portions of the data in the medical information as duplicate data.

21. The tangible computer readable medium of claim 20, wherein the receiving medical information comprises receiving one or more electronic medical records.

22. The tangible computer readable medium of claim 20, comprising further instructions for causing a computer to implement the step of selecting the medical information to be received.
